(19) United States
(12) Patent Application Publication
(10) Pub. No.: US 2020/0334778 A1
(43) Pub. Date: Oct. 22, 2020

(54) SYSTEMS AND METHODS FOR PROVIDING SITUATIONAL AWARENESS TO FIRST RESPONDERS

(71) Applicant: Nextivity, Inc., San Diego, CA (US)

(72) Inventor: Michiel Petrus Lotter, San Diego, CA (US)

(21) Appl. No.: 16/853,646

(22) Filed: Apr. 20, 2020

Related U.S. Application Data
(60) Provisional application No. 63/009,887, filed on Apr. 14, 2020.
(60) Provisional application No. 62/836,548, filed on Apr. 19, 2019.

(51) Int. Cl. G06Q 50/26; G06K 7/14

(52) U.S. Cl. CPC G06Q 50/265; G06K 7/1417

(57) ABSTRACT

Systems and methods for providing situational awareness of a building to first responders are described. The system includes a server that receives and stores building information, such as a floor plan and other information. The system further includes one or more sensors that, whether or not periodically, senses situational awareness of the building and uploads that information to the server. A building identification affixed to the building allows a first responder to access the building information and situational awareness information at any time, such as during a situation or an incident, such as an emergency.

### CROSS-REFERENCE TO RELATED APPLICATIONS

The present application claims the benefit of U.S. Provisional Application No. 63/009,887, filed Apr. 14, 2020, and entitled “SYSTEMS AND METHODS FOR PROVIDING SITUATIONAL AWARENESS TO FIRST RESPONDERS”, and U.S. Provisional Application No. 62/836,548, filed Apr. 19, 2019, and entitled “SYSTEM FOR PROVIDING SITUATIONAL AWARENESS TO FIRST RESPONDERS”, the entire contents of which are incorporated herein by reference.

### TECHNICAL FIELD

The subject matter described herein relates to communications for first responders, such fire fighters, police, rescue personnel, etc., and more particularly to systems and methods for

### BACKGROUND

Real-time, accurate and detailed information about an emergency situation, commonly known as situational awareness, can often mean the difference between life and death. In particular, situational awareness information is critical for first responders to emergency situations. First responders include firefighters, police, emergency medical technicians, incident commanders, building maintenance personnel such as plumbers and HVAC technicians, information technology (IT) specialists such as communications technicians and computer and networking equipment specialists, and the like. Various means to provide accurate situational awareness to first responders exist today. One example is live video feeds captured by body mounted cameras, for example.

What is needed are systems and methods to provide first responders with fast, accurate and detailed situational awareness around emergency situations in a building, which will enable improved action by first responders on emergency situations.

### SUMMARY

In one aspect, a system for providing situational awareness of a building to first responders is described. The system includes a server that receives and stores building information, such as a floor plan and other information. The system further includes one or more sensors that, periodically or not periodically, sense attributes, conditions, state or other factors or situational awareness of the building, and uploads that information to the server. A building identification affixed to the building allows a first responder to access the building information and situational awareness information at any time, such as during an incident or emergency.

In other aspects, a method of providing situational awareness of a building to first responders is described. The systems and methods can be used by any type of first responder, such as fire department personnel, police, or even building maintenance or services personnel or agencies.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to situational awareness of a building for a first responder, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter; and

FIG. 2 shows a process flow diagram illustrating aspects of a method having one or more features consistent with implementations of the current subject matter.

When practical, similar reference numbers denote similar structures, features, or elements.

### DETAILED DESCRIPTION

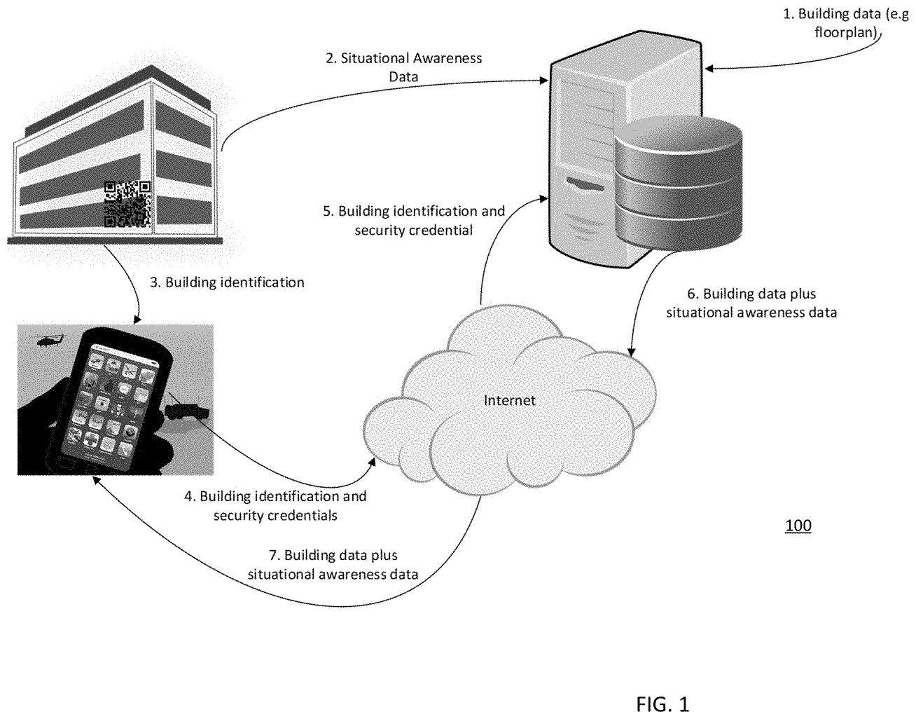

FIG. 1 illustrates a system 100. The system 100 includes a network of one or more sensors 2 to capture situational awareness information inside a building, and a unique, physical building identification 3 affixed to the building. The one or more sensors can include one or more of a temperature sensor, an accelerometer, an optical sensor, and infrared sensor, a LIDAR and/or RADAR sensor, a movement sensor, a pressure sensor, a humidity sensor, a building access monitor, a smoke or other particulate sensor, a biological or other microbial sensor, an air sensor for sensing gasses or pathogenic particulates in the air inside of the building, a geolocation sensor for locating one or more persons, devices or other objects within the building, and the like.

The building identification 3 can be one or more of a QR code or other graphical or digitally-generated, machine-readable code, a machine-readable sign such as one or more alphanumeric characters that can be scanned by a scanning device and determined by an optical character recognition system and/or software, and other identifiers or identifications. The building identification 3 can be affixed to, or proximate the building, such as on a plaque on a wall or outer surface of the building, or affixed to a sign on or near the building, or embedded in a ground area near the building. The affixation can be by glue, bolt, screw, nail, cement, or the like, and is preferably fire-proof or fire resistant, as well as resistant or accommodative to other environmental elements such as rain, wind, humidity, temperature, etc. The building identification 3 can store or represent an identification of the building and information about the building, such as floorplan information, number of occupants. The building identification 3 can be used to associate a building identifier with other building-related information and data stored in a database or on a server.

The system 100 further includes a server and/or web based application 4 that stores the building information as well as the situational awareness data collected from the one or more sensors 2, the application 4 allowing access from the server to the building information and situational awareness data 6. The situational awareness data can be collected and/or uploaded to the server on a regular basis, i.e. hourly, daily, or any other regular or irregular period of time. For instance, the situational awareness data can be monitored locally for a change in any selected variable or attribute that exceeds a certain threshold, which can in turn trigger a new collection of one or more data by at least one of the one or more sensors. For example, if an internal temperature of the building rises more than 10 degrees within a predetermined time frame (i.e. 10 minutes), a temperature sensor can collect temperature data and immediately upload that data to the server and/or web application.

The server can be a single server computing machine, a collection of server computing machines, one or more virtual machines, a cloud-based server in a cloud computing infrastructure, or server software being executed on a computing machine. In some implementations, the sensor network 2 is integrated with an in-building radio coverage system. The situational awareness data is stored for immediate analysis and/or analysis at a later stage, including for use in forensic analysis of the events surrounding a situation or an incident.

The system 100 can further include an Artificial Intelligence (AI) module within the server or application to provide real-time guidance to first responders, such as relating to the best course of action to be taken. Further still, at least one of the one or more sensors can include Artificial Intelligence (AI) to allow that sensors to determine, in real-time, alert conditions independent of the server or web based application, for alerting the first responders and/or other sensors and local computing infrastructure.

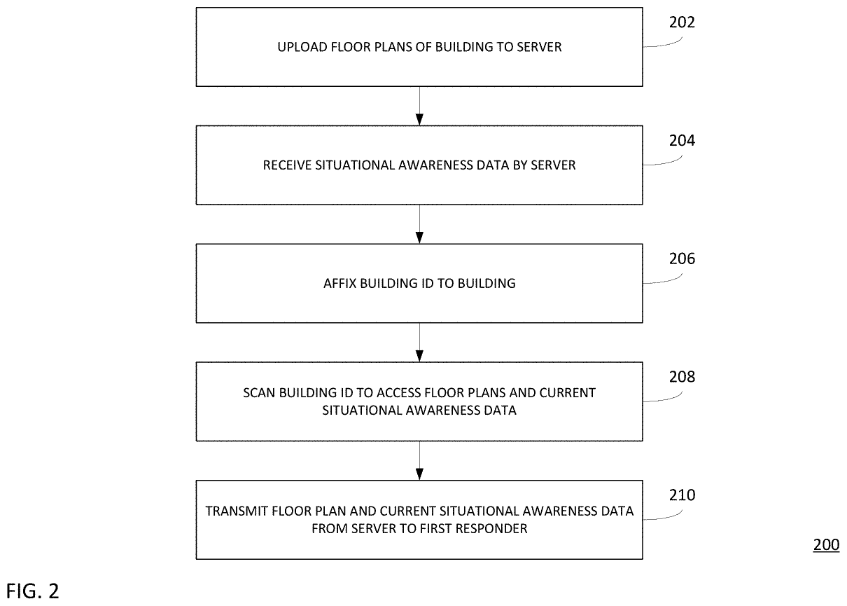

FIG. 2 is a flowchart of a method 200 for providing situational awareness to first responders. At 202, floor plans of a building are uploaded to a server. This step can be executed well in advance of an incident or situation. For example, uploading to a server and storage of the floor plans may be part of the process to receive a Certificate of Occupancy for a specific building. Or, such step can be part of a building's safety certification process by a governmental agency. The floor plan data can be encrypted, either by the uploading computer, or by the receiving server and/or application. The floor plan data can be decrypted in a downloading process, such as during an incident or situation related to the building, and only by a first responder with proper credentials or identification, or authority. As used herein, the term first responder can refer to an individual, a group of individuals, an entity such as a Fire Department, Police Department, or other governmental department or agency, or an enterprise such as a commercial security company or other type of company, such as an Information Technology (IT) department of a company that occupies at least some of the building.

The floor plan data can include, without limitation, a plan view of walls, furniture, equipment, and other infrastructure and/or occupants of a floor or part thereof. The floor plan data can also include a representation of the layout and/or location of sensors and controls, such as temperature and lighting controls, smoke alarms, air conditioning vents, baffles, gates, switches, and the like. The floor plan data can further include a catalog of specific materials of objects, such as furniture, carpeting, paint, walls, etc., used in the building.

At 204, a system installed in the building provides situational awareness data to the server where this data is stored and analyzed. The sensor types are described above, and an example of such a system may be a sensor network measuring temperature and air quality, at least in specific areas or regions of the floor plan of the building.

At 206 a Building Identification is affixed to the building in some fashion to uniquely identify the building. An example of a Building Identification could be a “QR Code” that encodes information about the building, such as information unique to the building. It should be noted that this, and other, steps need not be accomplished in the order depicted in FIG. 2, but can be performed in any order. For example, the Building Identification can be affixed to or near the building once the framing of the building is complete, so as to be registrable in a database even before the building is fully built-out. Accordingly, the Building Identification can be scanned or otherwise accessed at any point of the building's life cycle so as to provide identifying information for a first responder irrespective of a current point of that life cycle.

During a situation or an incident, or at any time deemed necessary, at 208 a first responder can access situational awareness information and data about the building by, for example, scanning the QR code with a mobile device running a scanning application, and providing login credentials to the mobile device that is connected with a server over a network, to get access to data on the server via the Internet or a secure network such as FirstNet, which is the nationwide broadband network established for use by first responders.

At 210, the building identification and user credentials are sent to the server, which provides access to the building information (such as the floor plan data described above), as well as situational awareness information (also as described above, such as the temperature or air quality at various points inside the building). The building information can be stored in a database associated with the server, or on the server itself. The data is sent from the server back to the first responder, so that they may use this information to enhance decision making. For example, knowing that the environment in a part of the building is conducive to flashover conditions may inform a decision to keep first responders out of this area. The information returned from the server can be augmented by AI, which can enhance the decision-making. The information can be decrypted and/or formatted in any way, such as a series of graphical elements for display in a graphical user interface on a client computing device, such as a tablet computer, a mobile communication device, a laptop computer, or the like. The information can be prioritized for display to the first responder, such as, for example, highlighting potential fire data in relation to the floor plan over air quality of a different region of the floor plan.

Information and data communicated on the system 100 can be transmitted according to any type of protocol or format, and preferably uses high-speed wireless communications. However, the system 100 can utilize any number of communication standards, protocols, and/or technologies, such as WiFi, Bluetooth, or the like. Communication with the first responder can use voice-activated commands, or text-to-speech conversion, so that a first responder can get information audibly and not just visually. Further, the system 100 can utilize haptic controls or feedback by first responders, and utilize other augmented reality (AR) technologies for optimal interaction between the system 100 and first responders. Such interaction can occur through a client application running on a client computing device, such as a smart phone, tablet computer, or the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system for providing situational awareness of a building to a first responder to an emergency situation at the building, the system comprising:
a server computer that receives and stores, in a memory, building data about the building;
one or more sensors associated with the building to sense one or more conditions of the building to generate situational awareness data, the one or more sensors each being configured to transmit the situational awareness data to the server computer for storage with the building data;
at least one building identification affixed to or positioned proximate the building, the building identification including a machine-readable code that identifies the building; and
a client application executable by a client computer that is configured to read the machine-readable code, the client application receiving the machine-readable code and being configured to access, based on the machine-readable code and via a communications network, the building data and the situational awareness data from the server computer.

2. The system in accordance with claim 1, wherein the one or more sensors include one or more of a temperature sensor, an air quality sensor, a smoke sensor, a humidity sensor, and a moisture sensor.

3. The system in accordance with claim 1, wherein the client application is further configured to receive user credentials from the first responder, and to authenticate the first responder to enable the access to the building data and the situational awareness data from the server computer.

4. The system in accordance with claim 1, wherein the communications network includes a secure wireless broadband link.

5. The system in accordance with claim 1, wherein the machine-readable code includes a barcode.

6. The system in accordance with claim 5, wherein the barcode is a two-dimensional matrix barcode.

7. The system in accordance with claim 1, wherein the building data includes a floorplan of the building.

8. A method of providing situational awareness of a building to a first responder to an emergency situation at the building, the building having one or more sensors to generate situational awareness data, the first responder using a client computer that runs a client application, the client computer being configured to read a machine-readable code that identifies the building, the method comprising:
receiving, by a server computer, building data about the building;
storing, by the server computer, the building data in a database;
receiving, by the server computer, the situational awareness data from the one or more sensors;
storing, by the server computer, the situational awareness data in the database with the building data;
receiving, by the server computer from the client computer, an identification of the building based on the machine-readable code;
accessing, by the server computer, the situational awareness data and building data from the database; and
transmitting, by the server computer, the situational awareness data and building data to the client computer via a communications network.

9. The method in accordance with claim 8, wherein the one or more sensors include one or more of a temperature sensor, an air quality sensor, a smoke sensor, a humidity sensor, and a moisture sensor.

10. The method in accordance with claim 8, further comprising:
receiving, by the server computer, user credentials from the first responder to authenticate the first responder to enable the accessing the building data and the situational awareness data from the database.

11. The method in accordance with claim 8, wherein the communications network includes a secure broadband link.

12. The method in accordance with claim 8, wherein the machine-readable code includes a barcode.

13. The method in accordance with claim 12, wherein the barcode is a two-dimensional matrix barcode.

14. The method in accordance with claim 8, wherein the building data includes a floorplan of the building.

15. A system for providing situational awareness of a building to a first responder to an emergency situation at the building, the building having one or more sensors to generate situational awareness data, the first responder using a client computer that runs a client application, the client computer being configured to read a machine-readable code that identifies the building, the system comprising:
a programmable processor; and
a non-transitory machine-readable medium storing instructions that, when executed by the processor, cause the at least one programmable processor to perform operations comprising:
receive building data about the building;
store the building data in a database;
receive the situational awareness data from the one or more sensors;
store the situational awareness data in the database with the building data;
receive, from the client computer, an identification of the building based on the machine-readable code;
accessing the situational awareness data and building data from the database; and
transmitting the situational awareness data and building data to the client computer via a communications network.

16. The system in accordance with claim 15, wherein the one or more sensors include one or more of a temperature sensor, an air quality sensor, a smoke sensor, a humidity sensor, and a moisture sensor.

17. The system in accordance with claim 15, wherein the client application is further configured to receive user credentials from the first responder, and to authenticate the first responder to enable the access to the building data and the situational awareness data from the server computer.

18. The system in accordance with claim 15, wherein the communications network includes a secure wireless broadband link.

19. The system in accordance with claim 15, wherein the machine-readable code includes a barcode.

20. The system in accordance with claim 1, wherein the building data includes a floorplan of the building.
